(19) United States
(12) Patent Application Publication
(10) Pub. No.: US 2026/0222059 A1
(43) Pub. Date: Jul. 30, 2026

(54) Management of Service Continuity of a Cell Area of a Satellite Network

(71) Applicant: Skylo Technologies, Inc., Mountain View, CA (US)

(72) Inventors: Andrew Nuttall, Mountain View, CA (US); Meghna Agrawal, Cupertino, CA (US); Soham Dhiren Desai, Palo Alto, CA (US); Christopher Acker, San Mateo, CA (US); Ashrith S R, Espoo (FI)

(73) Assignee: Skylo Technologies, Inc., Mountain View, CA (US)

(21) Appl. No.: 19/235,696

(22) Filed: Jun. 12, 2025

Related U.S. Application Data
(60) Provisional application No. 63/751,711, filed on Jan. 30, 2025.

(51) Int. Cl. H04B 7/185; H04W 56/00; H04W 76/20

(52) U.S. Cl. CPC H04B 7/18547; H04B 7/1851; H04W 56/0045; H04W 76/20

(57) ABSTRACT

Apparatuses, methods, and systems for managing an interface of a satellite network between a wireless device and a service provider are disclosed. One method includes providing wireless satellite network coverage to a cell area, including determining mapping, wherein the mapping identifies a first serving wireless base station component, a second serving wireless base station component, a serving satellite, and a serving satellite access station for supporting wireless communication with a wireless device within the cell area, wherein the first wireless base station component and the second wireless base station component are mapped independently for each of the plurality of coverage cell areas, and wirelessly communicating with the wireless device within the cell area through the serving satellite access station, the first wireless base station component, the second wireless base station component, and the serving satellite.

### RELATED PATENT APPLICATIONS

This patent application claims the benefit of U.S. Provisional Patent Application Ser. No. 63/751,711 filed Jan. 30, 2025, which is herein incorporated by reference.

### FIELD OF THE DESCRIBED EMBODIMENTS

The described embodiments relate generally to wireless communications. More particularly, the embodiments described relate to systems, methods, and apparatuses for management of service continuity of a cell area of a satellite network.

### BACKGROUND

Low Earth Orbit (LEO) satellites orbit at relatively low altitudes. They are used for various applications, including communications, satellite imagery, and space exploration. LEO satellites offer advantages like low latency and the ability to be smaller and less expensive than satellites at higher altitudes. However, LEO satellites are not fixed in position relative to the earth, and therefore, an earth base station needs to update satellite communication with a wireless device located at a fixed location of a specific region (cell area) of the surface of the earth.

It is desirable to have methods, apparatuses, and systems for management of service continuity of a cell area of a satellite network.

### SUMMARY

An embodiment includes a method of managing service continuity of a cell area of a satellite network. The method includes providing, by a satellite network, wireless satellite network coverage to a cell area, wherein the cell area is one of a plurality of coverage cell areas of the satellite network, including determining mapping, by the satellite network, wherein the mapping identifies a first serving wireless base station component, a second serving wireless base station component, a serving satellite, and a serving satellite access station for supporting wireless communication with a wireless device within the cell area, wherein the first wireless base station component and the second wireless base station component are mapped independently for each of the plurality of coverage cell areas, wherein the second wireless base station component communicates with a wireless device within the cell area through the first wireless base station component, wherein the first serving wireless base station component is one of a plurality of available first wireless base station components and performs signal modulation and demodulation, and wherein the second serving wireless base station component is one of a plurality of available second wireless base station components and performs a radio resource control (RRC) function, and wirelessly communicating, by the satellite network, with the wireless device within the cell area through the serving satellite access station, the first wireless base station component, the second wireless base station component, and the serving satellite.

Another embodiment includes a satellite network. The satellite network is configured to provide wireless satellite network coverage to a cell area, wherein the cell area is one of a plurality of coverage cell areas of the satellite network, including the satellite network operating to determine mapping, wherein the mapping identifies a first serving wireless base station component, a second serving wireless base station component, a serving satellite, and a serving satellite access station for supporting wireless communication with a wireless device within the cell area, wherein the first wireless base station component and the second wireless base station component are mapped independently for each of the plurality of coverage cell areas, wherein the second wireless base station component communicates with a wireless device within the cell area through the first wireless base station component, wherein the first serving wireless base station component is one of a plurality of available first wireless base station components and performs signal modulation and demodulation, and wherein the second serving wireless base station component is one of a plurality of available second wireless base station components and performs a radio resource control (RRC) function, and wirelessly communicate with the wireless device within the cell area through the serving satellite access station, the first wireless base station component, the second wireless base station component, and the serving satellite.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows wireless communication coverage of a cell area within a wireless coverage region that includes multiple cells, according to an embodiment.

FIG. 2 shows a satellite network that manages service continuity of a cell area of the satellite network, according to an embodiment.

FIG. 3 shows a satellite network that manages service continuity of a cell area of the satellite network, according to another embodiment.

FIG. 4 shows a satellite network that manages service continuity of a cell area of the satellite network, according to another embodiment.

FIG. 5 shows a satellite network that manages service continuity of a cell area of the satellite network, according to another embodiment.

FIG. 6 shows an example of a mapping table that includes routing paths through the satellite network over time, according to an embodiment.

FIG. 7 shows a first wireless base station component that includes a radio resource scheduler of the satellite network, according to an embodiment.

FIG. 8 shows a satellite network that manages service continuity of cell areas of the satellite network, according to an embodiment.

FIG. 9 is a flow chart that includes steps of a method of managing service continuity of a cell area of the satellite network, according to an embodiment.

### DETAILED DESCRIPTION

The embodiments described include methods, apparatuses, and systems for management of service continuity of a cell area of a satellite network.

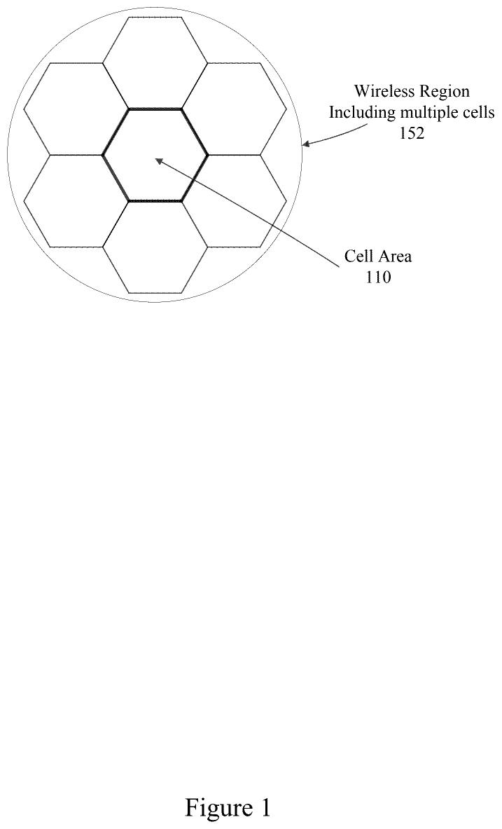

FIG. 1 shows wireless communication coverage of a cell area 110 within a wireless coverage region 152 that includes multiple cells, according to an embodiment. LEO satellites are not fixed in position relative to the earth, and therefore, an earth base station of a LEO satellite network needs to update satellite communication with a wireless device located at a fixed location of the cell area 110 of the surface of the earth.

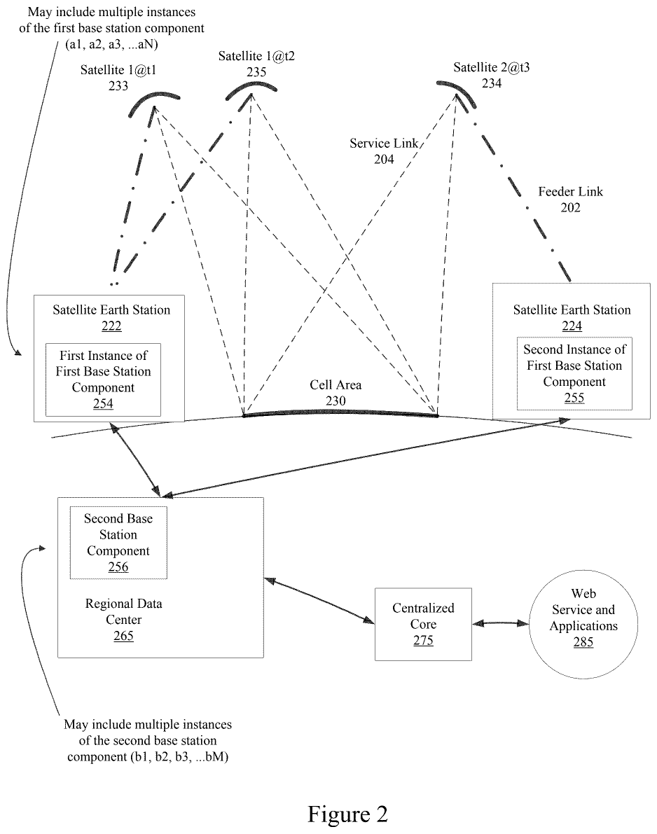

FIG. 2 shows a satellite network that manages service continuity of a cell area 230 of the satellite network, according to an embodiment. That is, the satellite network manages wireless coverage for wireless devices located within the cell area 230. For at least some embodiments, the satellite network provides network mobility management. That is, the satellite network provides seamless, reliable, and efficient connectivity and service continuity as satellites 233, 234, 235 traverse their orbits and wireless devices (not shown) transition across network (cell area) boundaries. In a LEO (low Earth orbit) satellite network, a wireless device may be serviced by different satellites, beams, and or earth stations, creating a mobility environment that needs to be resolved. In the satellite network, mobility can be managed through the use of earth-fixed cells (such as, cell area 230) and beam scheduling with mapping technology.

For an embodiment, earth-fixed cells (such as, cell area 230) with beam steering technology are used to maintain consistent coverage over specific geographical areas. This ensures that base stations (composed of first and second wireless base station components 254, 256) remain focused on the same regions and retain the same Physical Cell Identifier (PCI), even as satellites move in their orbits. These geographical areas are referred to as cells.

For an embodiment, this is made possible through beam steering capabilities of each satellite when the satellite dynamically adjusts its beams to stay aligned with target areas on earth, as well as through dynamic beam-to-RAN mapping when dynamic mapping of satellite beams to the RAN network stack maintains seamless connectivity.

For a stationary wireless device within the cell area 230, the PCI (Physical Cell Identifier) on the ground remains constant. However, the satellite serving the device changes periodically. It is crucial for the device to have advanced knowledge of the next satellite that will serve it. To ensure seamless connectivity, the wireless device receives essential information, including the service time, the frequency of operation, the ephemeris of the upcoming satellite along with the details of the current serving satellite.

As shown, for an embodiment, the satellite network that includes the regional data center, the earth stations 254, 255, and satellites 233, 234, 235 provide wireless satellite network coverage to the cell area 230, wherein the cell area 230 is one of a plurality of coverage cell areas of the satellite network. For an embodiment, the satellite network determines mapping, wherein the mapping identifies a first serving wireless base station component 254, a second serving wireless base station component 256, a serving satellite 233, 234, 235, and a serving satellite access station 222, 224 for supporting wireless communication with a wireless device within the cell area 230. For an embodiment, the first wireless base station component 254 and the second wireless base station component 256 are mapped independently for each of the plurality of coverage cell areas, wherein the second wireless base station component 256 communicates with a wireless device within the cell area 230 through the first wireless base station component 254 (as defined by the mapping), wherein the first serving wireless base station component 254 is one of a plurality of available first wireless base station components and performs signal modulation and demodulation (that is, performing the modulation and demodulation of wireless signals communicated between the first wireless base station component 254 and the wireless device within the cell area 230), and wherein the second serving wireless base station component 256 is one of a plurality of available second wireless base station components and performs a radio resource control (RRC) function. For an embodiment, the satellite network then wirelessly communicates with the wireless device within the cell area 230 through the serving satellite access station, the first serving wireless base station component, the second serving wireless base station, and the serving satellite.

### Mapping

As previously described, the mapping identifies a first serving wireless base station component 254, a second serving wireless base station component 256, a serving satellite 233, 234, 235, and a serving satellite access station 222, 224 for supporting wireless communication with a wireless device within the cell area 230. As the satellites of the satellite network constantly move, the mapping is dynamically updated over time based on the current locations of the satellites of the satellite network. Accordingly, the serving satellite is updated over time to maintain wireless coverage of the cell area 230. Further, the first serving wireless base station component of a current mapping is updated over time as well. As previously described, for an embodiment, the first wireless base station component 254 and the second wireless base station component 256 are mapped independently for each of the plurality of coverage cell areas. For an embodiment, independent mapping means any instance of the first component can connect with any other instance of the second component based on one or more mapping criteria, such as, the relative locations of the first wireless base station component and the second wireless base station component, location of the satellites, location of the satellite earth station, satellite power, and/or network load.

For an embodiment, the serving satellite is the satellite that is selected and currently provides wireless access service over the cell area. Further, the serving first component, the serving second wireless base station component, the serving satellite earth station are all currently selected and currently providing wireless access service over the cell area.

For an embodiment, the second serving wireless base station component supporting wireless coverage in the cell area remains static over time as the serving satellite changes. For an embodiment, the second serving wireless base station component provides high-level (Layer 2, Layer 3) control, such as, radio resource control (RRC) functions. For an embodiment, the second serving wireless base station component remains focused (that is, serves the same fixed cell(s)) on the same regions and retains the same Physical Cell Identifier (PCI), even as satellites move in their orbits.

For an embodiment, the first serving wireless base station component supporting wireless coverage in the cell area changes over time as the serving satellite changes. For an embodiment, the first serving base station component provides low-level (L1) functionality.

### Radio Resource Control (RRC)

For at least some embodiments, the Radio Resource Control (RRC) protocol is used in UMTS (Universal Mobile Telecommunications System), LTE (Long Term Evolution) and 5G on the Air interface. It is a layer 3 (Network Layer) protocol used between UE (wireless device) and Base Station. This protocol is specified by 3GPP (3rd Generation Partnership Project) in TS 25.331 for UMTS, in TS 36.331 for LTE and in TS 38.331 for 5G New Radio. RRC messages are transported via the PDCP (Packet Data Convergence Protocol)-Protocol.

The major functions of the RRC protocol include connection establishment and release functions, broadcast of system information, radio bearer establishment, reconfiguration and release, RRC connection mobility procedures, paging notification and release and outer loop power control. By means of the signaling functions the RRC configures the user and control planes according to the network status and allows for Radio Resource Management strategies to be implemented.

### First and Second Wireless Base Station Components

In a typical wireless network, the base station typically provides functionality across a number of network layers. This includes an L1 set of functionalities that is responsible for converting analog signals into demodulated bits, and vice versa (modulation and demodulation of wireless communication signals). This L1 functionality is often very sensitive to physical wireless link parameters such as timing delay, signal strength, frequency error etc.

Further, the typical base station includes higher level functions (L2, L3) that handle session management, authentication, data routing etc. This type of functionality is sensitive to managing interactions with a wireless device.

However, in a satellite network (such as, a LEO satellite network), under normal conditions a wireless device could have different satellites overhead all the time. For example, a new/different satellite may be overhead every 60 seconds. In some existing satellite networks, a base station is associated with a satellite, such that a wireless device may see a new base station every 30 seconds. Supporting such a configuration is onerous for the satellite network, and for both the wireless device and base station. This is especially true for the high-level functions (such as, L2 and L3) of the base station that handles sessions (sustained wireless communication) with the wireless device. However, the sessions are constantly interrupted because the satellites are moving.

In contrast, the described embodiments include a base station (second wireless base station component) dedicated to a specific cell on the earth such that a wireless device within the specific call always sees (within wireless coverage of) the same base station (second wireless base station component) such that its session is not constantly interrupted. For an embodiment, a wireless device in a specific cell area is connected to a common second wireless base station component, but the satellites and first wireless base station component change as the satellites are in motion.

The satellite network (for example, a LEO satellite network) is challenging because not only are the satellites that provide coverage over a given area (cell area) changing over time, core wireless channel characteristics like time delay, signal strength, or frequency error are changing over time. Accordingly, an embodiment includes assigning the lower level (such as, L1) functions of the base station to a first wireless base station component to handle the changing wireless conditions. At least some embodiments further include dynamically connecting (per the identified mapping) different lower level base station components (first wireless base station component) to higher level network components (second wireless base station component) to ensure that a fixed high layer base station component (second wireless base station component) is connected to the lower layer base station component (first wireless base station component) that happens to be inside a current overhead serving satellite or a current serving satellite access station. That is, the first wireless base station component may be located at either the serving satellite or the serving satellite earth station.

The described embodiments that include independent mapping of first wireless base station component and second component allows for an efficient satellite network management system where in the overall availability, latency, performance, requirements of the whole satellite network system can be optimized rather than individual satellite ground station pairs as previously implemented.

As previously described, for an embodiment, a location of the second wireless base station component 256 can change over time. The location of the second wireless base station component 256 location can dynamically change. In one instance the second wireless base station component can be located at the earth station and in another instance, the second wireless base station component can be located at the regional data center 265. The second wireless base station component location can be changed dynamically based on the relative location of the serving satellite, the next serving satellite as per the mapping, and the satellite earth station. For an embodiment, if both serving satellite and next serving satellite are connected to the same satellite earth station, then the second wireless base station component can be located at the same satellite earth station. For an embodiment, if the serving satellite and next serving satellite are connected to different satellite earth stations, then the second wireless base station component can be located at regional data center 265 closer to the satellite earth stations. In one case both the satellite earth stations can be connected via a fiber link and one satellite earth station itself can act as the regional data center and a host second satellite earth station.

As shown in FIG. 2, the serving satellite of the coverage area 230 changes over time. For example, at a first time t1, satellite 1 233 may be providing the wireless coverage of the coverage area 230, at a second time t2, satellite 1 235 may be providing the wireless coverage, and a time t3, satellite 2 234 may be providing the coverage. Accordingly, the mapping of devices (satellite, first and second wireless base station components, satellite earth station) between a wireless device and the regional data center is dynamically changing. For example, at time t1 the mapping may include a satellite 233, the first wireless base station component 254 within the satellite earth station 222, and second wireless base station component 256 within the regional data center 265, and at time t3 the mapping may include a satellite 234, the first wireless base station component 255 within the satellite earth station 224, and second wireless base station component 256 within the regional data center 265.

As shown, the satellites are wirelessly connected to the satellite earth stations through feeder links 202, and the satellites are connected to wireless devices within the coverage area 230 through service links 204.

As shown, the regional data center 265 may be connected to a centralized core 275, which may then be connected to web service and applications 285. For an embodiment, the regional data center 265 hosts the second base station component, along with a wireless device context. For an embodiment, web service and applications 285 provide satellite connectivity services to the customers of the wireless devices via the satellite network.

As will be described, the first wireless base station component may be implemented with multiple instances a1, a2, a3, . . . aN, wherein for an embodiment, each instance processes signals for a different satellite beam from one or more satellites. Further, the second wireless base station component may be implemented with multiple instances b1, b2, b3, . . . bM, wherein for an embodiment, each instance is associated with a different physical cell area or channel. For an embodiment, each instance of the first base station component is mapped to a single instance of second base station component. For an embodiment, multiple instances of the second base station component are mapped to single instance of first base station component.

For an embodiment, the second wireless base station component is configured to generate initial system information blocks. Further, for an embodiment, the first wireless base station component is configured to update the system information blocks based on the mapping of the serving satellite and the first wireless base station component. The system Information Blocks (SIBs) are broadcast messages from the base station (first and second wireless base station components) to the wireless devices that contain essential information about the satellite network. System Information Blocks (SIBs) are broadcast messages from the base station to the wireless devices that contain essential information about the access systems like LTE, 5G, NB IOT. For an embodiment, the second wireless base station component is responsible for layer 2, layer 3, and upper-layers operations in a typical LTE or 5G network. For an embodiment, the RRC layer, which is the Radio Resource Configuration layer, decides where System Information Blocks (SIB) are sent over the network, its patterns, etc. For an embodiment, the data within such SIBs is not available to second wireless base station component. Therefore, the first wireless base station component fills in that information, completes the SIBs and sends it over the air interface. A satellite data block provides information about which satellite is used so that the correct ephemeris information is provided and updated.

For an embodiment, the second wireless base station component provides information within the SIB and the SIB schedule, wherein the SIB schedule includes periodicity, and repetition levels for SIBs. For an embodiment, the second wireless base station component updates fields which depend upon the parameters of the fixed earth cell 230 covered by the second wireless base station component, such as Physical cell Id, EARFCN (E-UTRA Absolute Radio Frequency Channel Number). For an embodiment, the information of the SIB includes at least parts of the SIB cell, such as cell ID, cell access, access barring, PRACH (physical random-access channel) resources which are fixed for a particular cell. For an embodiment, the first wireless base station further updates fields based on latest satellite data, such as, a serving satellite ephemeris, and neighboring satellite ephemeris.

For an embodiment, the mapping is based at least in part on locations of the serving satellite and the serving satellite access station and locations of instances of the first wireless base station component and the second wireless base station component. For an embodiment, mapping between instances of the first wireless base station component and instances of the second wireless base station component are selected to maintain latency between them less than or within a certain threshold. For an embodiment in which latency is critical for the coverage area, the second wireless base station component which is closest to the second wireless base station component is selected and included in the mapping. For an embodiment, the location of the regional data center is selected to keep the latency between the first wireless base station component and the second wireless base station component within a threshold (e.g. <10 msec). For an embodiment, the latency threshold is selected based on the wireless communication protocol used between the first wireless base station component, the second wireless base station component, and the wireless device and type of services supported. For example, latency is more critical for voice services than the delay tolerant data services.

For an embodiment, the mapping is based at least in part on current stored power available of the serving satellite. That is, in some situations multiple satellites may be available for selection and inclusion in the mapping. However, satellites are self-powered, and in some situations may be running low in power. Accordingly, the selection of the serving satellite for inclusion in the mapping may be influenced by the current stored power of the available satellites to avoid selection and inclusion within the mapping satellites that are low in stored power. For an embodiment, the mapping is identified based on the relative satellite and satellite access location. Further, for an embodiment, the mapping and mapping tables can also be based on the current satellite stored power and network load. That is, satellites usually have a finite battery capacity and obtain power using solar cells. For an embodiment, the mapping table is optimized such that the satellite can serve the cells even when not directly under the sun (in shade). In addition, for an embodiment, the traffic load on each satellite beam in previous instances also influences which satellite is selected. For example, if satellite A has used a higher power in the previous time window and satellite B has used lower power, satellite B can be selected such that power is managed effectively amongst all satellites.

For an embodiment, the mapping is based at least in part on a network load. For an embodiment, when the network load is high then the second wireless base station component with higher processing power can be included in the mapping.

At least some embodiment, further include determining a radio resource schedule by the first wireless base station component based on a timing estimation information or channel estimation information between the wireless device and the first wireless base station component. For an embodiment, the radio resource schedule defines frequency and time slots for uplink and downlink channels. For an embodiment, the timing estimation information includes timing advance adjustment by the first wireless base station component. For an embodiment, the timing advance adjustment includes doppler and timing correction based on satellite ephemeris information of the serving satellite. For an embodiment, the timing includes timing advance adjustment by the base station based on the feedback received from the wireless device. For an embodiment, the timing adjustment also includes the doppler and timing correction based on the satellite ephemeris information of the connected satellite.

For an embodiment, radio resource control related timers and parameters are defined based on a latency between the first wireless base station component and the second wireless base station component. Some of the examples of radio resource control related timers include a contention resolution timer, HARQ timer, wireless device wait time, RRC Connection timers.

At least some embodiments further include updating by a mapping table, channel routing information including a selection of channel allocation, a feeder link channel, a serving satellite selection, a first wireless base station component selection, and a second wireless base station component selection.

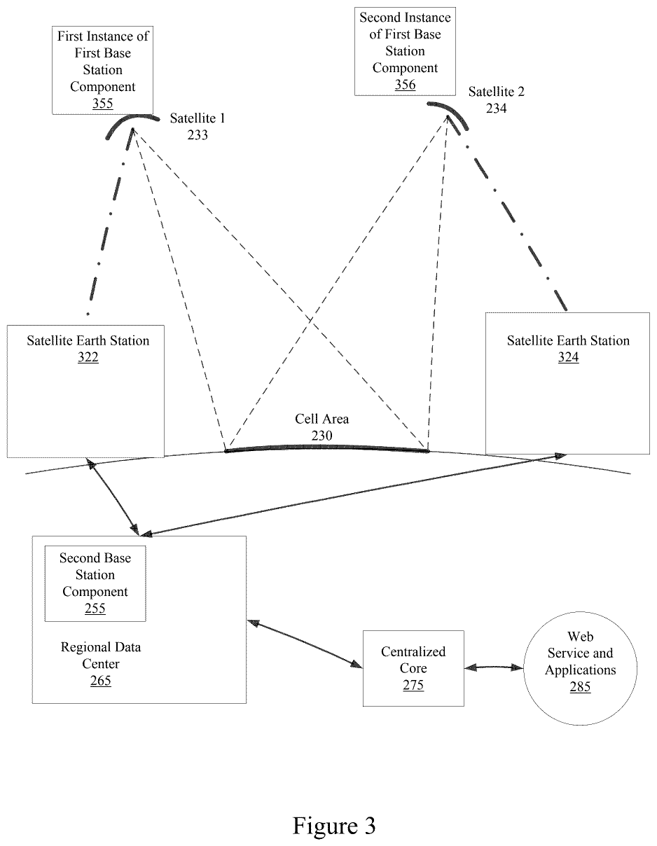

FIG. 3 shows a satellite network that manages service continuity of a cell area of the satellite network, according to another embodiment. FIG. 3 illustrates the location of the first wireless base station component being located within the serving satellite. As the serving satellite changes over time as the locations of the satellites change, different instances of the first wireless base station component 355, 356 are located in different satellites 233, 234. As described, a current mapping determines which satellite and first base station component are currently operating as the serving satellite and serving first base station component.

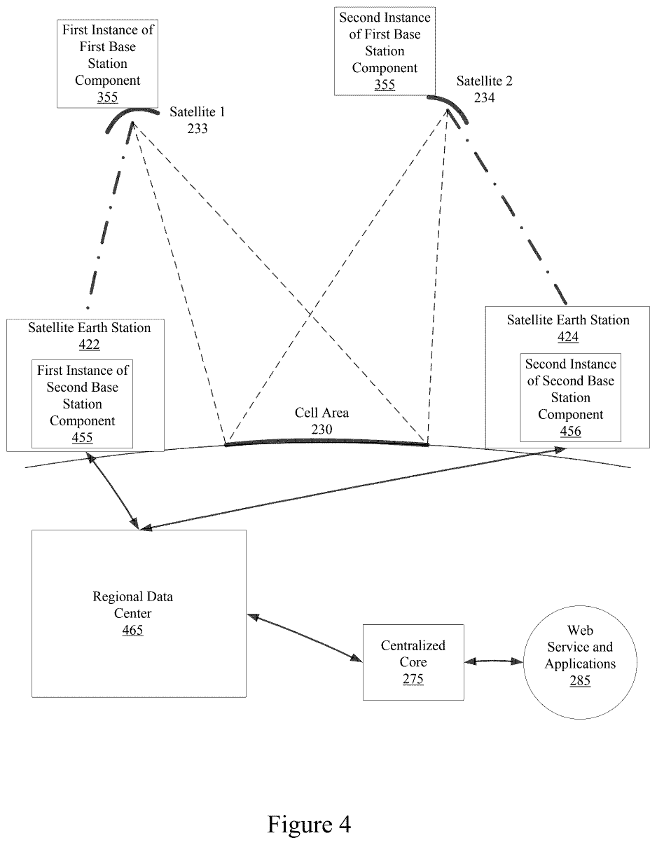

FIG. 4 shows a satellite network that manages service continuity of a cell area of the satellite network, according to another embodiment. FIG. 4 illustrates the location of the second wireless base station component being located within the serving satellite earth station. Here, different instances of the second wireless base station component 455, 456 are located in different satellite earth stations 422, 424 which are connected to the regional data center 465.

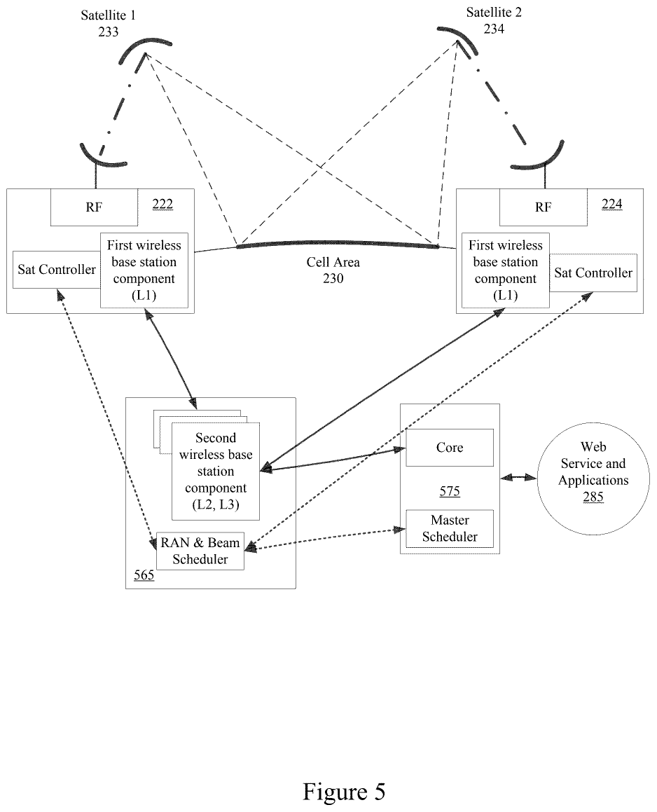

FIG. 5 shows a satellite network that manages service continuity of a cell area of the satellite network, according to another embodiment. This embodiment provides a distributed RAN (radio access network) Architecture and dynamic beam mapping. A stage 1 of the distributed RAN architecture includes a satellite network architecture that includes a distributed RAN design, with the RAN Layer 1 functions deployed at a first base station component ground (satellite earth) stations and the RAN Layer 2 and Layer 3 stacks hosted or at second base station component regional data centers. To maintain earth-fixed beams, the regional RAN stacks are mapped to consistent geographical regions (clusters of cells) on the Earth, where each cluster can contain one or more cells. This mapping is managed by a master scheduler, which orchestrates scheduling and coordination across the network components. For an embodiment, a master scheduler generates the mapping table which is distributed to the regional data centers and satellite access stations. A topology of the distributed RAN for Stage 1 is shown in FIG. 5. A Radio Access Network (RAN) is a crucial part of a cellular network that connects end-user devices (like smartphones) to the internet via radio waves. It's the visible part of the network, including base stations, antennas, and other hardware that facilitate wireless communication. The RAN handles the radio communication between devices and the core network, which connects to the internet.

This embodiment of the satellite network utilizes a multi-tiered scheduling system to effectively manage mobility and ensure seamless connectivity during satellite transitions. This system is composed of a Master Scheduler (shown within the core 575), a RAN & Beam Scheduler (shown within the data center 565), and a Satellite Controller (shown within the satellite earth stations 222, 224), all working in tandem. For an embodiment, the Master Scheduler plays a critical role in managing the overall beam planning and coordination between satellite motion and geographical cells. It ensures the correct mapping of cells, satellites, beams, ground stations and data centers across the entire network. This mapping information is then passed on to the regional RAN & Beam Scheduler to facilitate seamless interconnections between the regional data centers and the ground station gateways.

For an embodiment, the Master Scheduler has awareness of the satellite's phased array and therefore understands its beam forming capabilities. For an embodiment, the Master Scheduler will take these capabilities into account when deciding a mapping between cells and beams. For an embodiment, the Master Scheduler ensures the satellite is capable of creating a pattern that satisfies the cell-to-beam mapping through simulations, and if the Satellite Controller is not capable, it can request another mapping from the master scheduler. The Master Scheduler always tries to construct a schedule that optimizes the connectivity conditions for UEs on the network based on inputs such as SINR quality of beams, frequency of satellite switching, and possibly other parameters such as geography/topology, weather, UE density, among other parameters. (e.g. if a satellite is very far away, the signal might be weaker, but it might also be beneficial for a UE to be mapped to a specific satellite for the longest duration possible; this presents a trade off, and solving this trade off is an optimization problem).

### Power Management by Master Scheduler

With the LEO satellite network each cell can have coverage from 2 or more satellites simultaneously. The satellites have limited power and battery. For an embodiment, the Master scheduler also includes satellite available power and traffic load for choosing the optimum beams for the given geographical cell.

For an embodiment, the RAN & Beam Scheduler utilizes the mapping data from the Master Scheduler to oversee the interconnection between the L1 stack at the gateway and the regional RAN components. For an embodiment, the RAN & Beam Scheduler also provides the necessary beamforming and feeder link mapping information to earth stations, ensuring timing synchronization and communication with the satellite beams. At the ground stations, the Satellite Controller ensures satellite operation by delivering beam forming and channel mapping information to the satellite, facilitating desired beam formation by the satellite. It also manages feeder link switching, allowing a RAN stack to connect to the appropriate satellite beams according to the predefined schedule. This ensures continuous service as satellites transition in their orbits.

For an embodiment, a high-quality link between the earth station and regional data centers is employed to reduce latency and jitter in communication. Additionally, the RAN stack utilizes buffering to mitigate any jitter between the regional data center and earth station link, ensuring timing synchronization across all components.

The RAN stack broadcasts satellite ephemeris data according to the satellite and beam mapping, following standard defined protocols for synchronization and beam alignment. Additionally, ‘Standards Plus’ features will be implemented to enable satellite switching without service disruption, particularly for NB-NTN. In situations where mapping is not formed to establish earth fixed beams, the system will treat the transition as if the user has moved from one cell to another. The core network context will be preserved in such scenarios, eliminating the need for a network re-attachment.

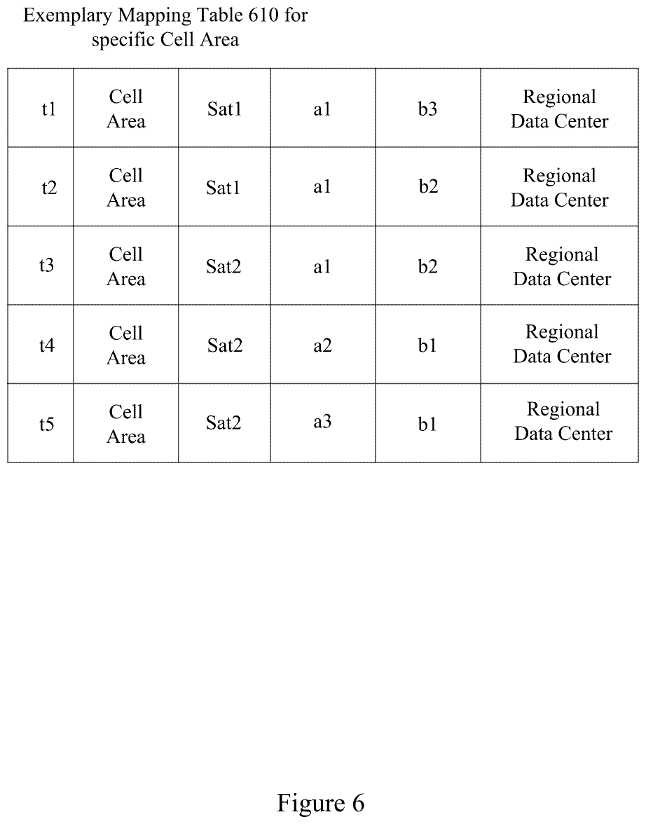

FIG. 6 shows an example of a mapping table of routing paths through the satellite network over time, according to an embodiment. As previously described, the mapping provides a routing path of the devices (serving satellite, serving first wireless base station component, satellite earth station, second wireless base station component) between a wireless device within the coverage area 230 and the regional data center 265. As shown, overtime t1, t2, t3, t4, t5 the routing path changes as the satellite locations and other conditions of the satellite network change over time. For an embodiment, the mapping table also includes information about the serving satellite ephemeris and ephemeris data of the satellites serving neighboring cells. The map shown in FIG. 6 is for a single cell. For at least some embodiments, other cells have a similar type of map.

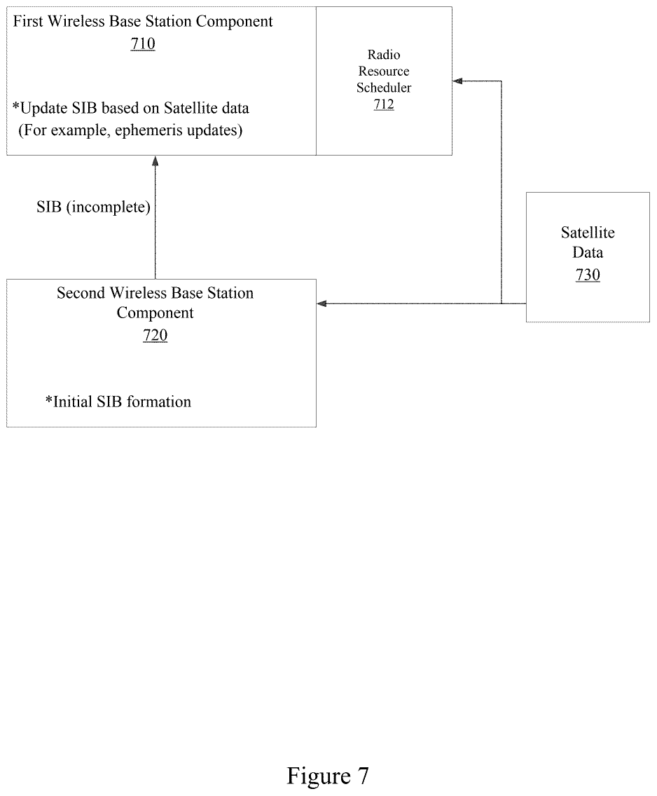

FIG. 7 shows a first wireless base station component 710 that includes a radio resource scheduler 712 of the satellite network, according to an embodiment. FIG. 7 shows the interaction between the first wireless base station component 710 and the second wireless base station component 720, along with a satellite data block 730. For an embodiment, the second wireless base station component 720 is responsible for layer 2, layer 3-, and upper-layers operations in a typical LTE or 5G network. For an embodiment, the RRC layer, which is the Radio Resource Configuration layer, decides where System Information Blocks (SIB) are sent over the network, its patterns, etc. For an embodiment, the data within such SIBs is not available to the second wireless base station component 720, and accordingly, for an embodiment, the first wireless base station component 710 fills in (provides) that information, completes the SIBs and sends it over the air interface. The satellite data block 730 shown provides information about which satellite is used so that the correct ephemeris information is provided and updated.

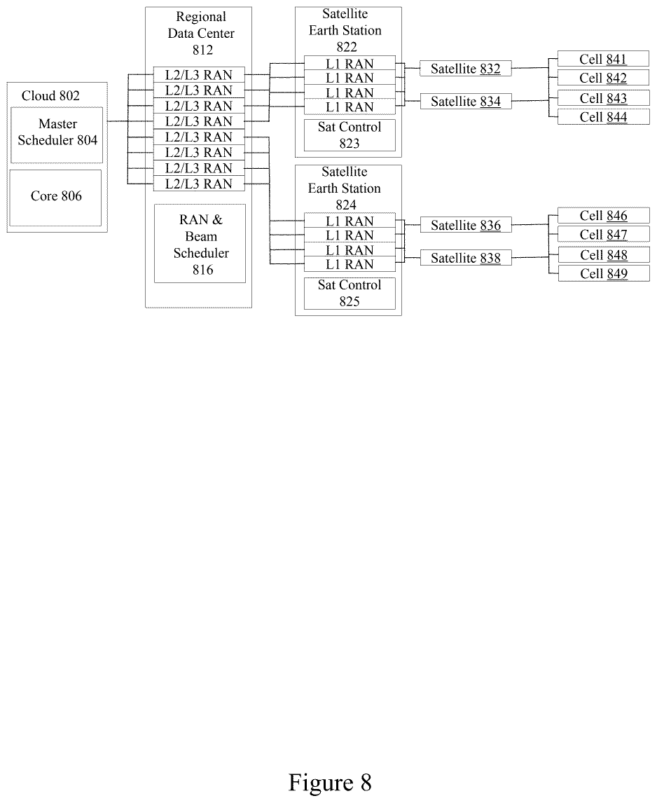

FIG. 8 shows a satellite network that manages service continuity of cell areas of the satellite network, according to an embodiment. A cloud 802 may include the master scheduler 804 and the core 806. A regional data center 812 includes layer 2 and layer 3 RAN (radio access networks) and a RAN & beam scheduler 816. Satellite earth stations 822, 824 include layer 1 RANs and satellite controllers 823, 825. Satellites 832, 834, 836, 838 provide wireless coverage to cell areas 841-849. For an embodiment, the master schedule 804 determines the mapping of the routing through the satellite network from the cloud 810 to the cell areas 841-849 over time.

For an embodiment, the coverage area is divided into various cells (hexagon typically) 841-849, the master scheduler which is operated on the cloud is responsible to ensure all cells 841-849 (or maximum number of cells) are provided with satellite coverage. To perform this function, for an embodiment, the master scheduler needs to allocate appropriate grouping of the second wireless base station component, the first wireless base station component, and Satellites for each cell. FIG. 8 shows an example of such a mapping scheme.

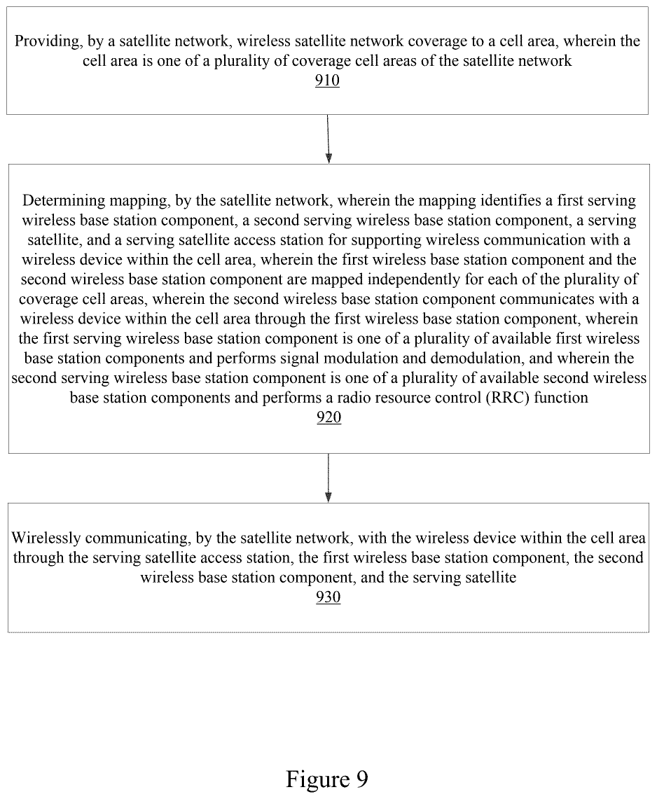

FIG. 9 is a flow chart that includes steps of a method of managing service continuity of a cell area of the satellite network. A first step 910 includes providing, by a satellite network, wireless satellite network coverage to a cell area, wherein the cell area is one of a plurality of coverage cell areas of the satellite network. A second step 920 includes determining mapping, by the satellite network, wherein the mapping identifies a first serving wireless base station component, a second serving wireless base station component, a serving satellite, and a serving satellite access station for supporting wireless communication with a wireless device within the cell area, wherein the first wireless base station component and the second wireless base station component are mapped independently for each of the plurality of coverage cell areas, wherein the second wireless base station component communicates with a wireless device within the cell area through the first wireless base station component, wherein the first serving wireless base station component is one of a plurality of available first wireless base station components and performs signal modulation and demodulation, and wherein the second serving wireless base station component is one of a plurality of available second wireless base station components and performs a radio resource control (RRC) function. A third step 930 includes wirelessly communicating, by the satellite network, with the wireless device within the cell area through the serving satellite access station, the first wireless base station component, the second wireless base station component, and the serving satellite.

For an embodiment, the second serving wireless base station component supporting wireless coverage in the cell area remains static over time as the serving satellite changes. For an embodiment, the first serving wireless base station component supporting wireless coverage in the cell area changes over time as the serving satellite changes. For an embodiment, a location of the second wireless base station component changes over time.

For an embodiment, the first wireless base station component includes multiple instances, wherein each instance processes signals for a different satellite beam from one or more satellites.

For an embodiment, the second wireless base station component includes multiple instances, wherein each instance is associated with a different physical cell area or channel. For an embodiment, each instance of the first base station component is mapped to a single instance of second base station component. For an embodiment, multiple instances of the second base station component are mapped to single instance of first base station component.

For an embodiment, the mapping further includes one or more of mapping between the first wireless base station component and the second wireless base station component, signal routing parameters, ephemeris broadcasting, or frequency allocation.

At least some embodiments further include generating initial system block information by the second wireless base station component and updating the system block information by the first wireless base station component based on mapping of the serving satellite and the first wireless base station component.

For an embodiment, the mapping is based at least in part on locations of the serving satellite and the serving satellite access station and locations of instances of the first wireless base station component and the second wireless base station component. For an embodiment, the mapping is based at least in part on current stored power available of the serving satellite. For an embodiment, the mapping is based at least in part on a network load. For an embodiment, the network load is determined by the number of wireless devices and the locations of the wireless devices within a cell area. For example, a majority of the wireless devices may be located in one cell which influences the mapping.

At least some embodiments further include determining a radio resource schedule by the first wireless base station component based on a timing estimation information or channel estimation information between the wireless device and the first wireless base station component. For an embodiment, the timing estimation information includes timing advance adjustment by the first wireless base station component. For an embodiment, the timing advance adjustment includes doppler and timing correction based on satellite ephemeris information of the serving satellite.

For an embodiment, radio resource control related timers and parameters are defined based on a latency between the first wireless base station component and the second wireless base station component.

At least some embodiments further include updating by a mapping table, channel routing information including a selection of channel allocation, a feeder link channel, a serving satellite selection, a first wireless base station component selection, and a second wireless base station component selection.

For an embodiment, one or more of the plurality of first base station components is collocated within a satellite. That is, regenerative satellites have onboard processing capabilities and can perform base station functions. For an embodiment, these regenerative satellites can demodulate, decode, route, code, and modulate signals, multiple first wireless base station components can be within a single satellite providing provision to serve multiple beams/coverage areas at once.

For an embodiment, one or more of the plurality of first base station components is collocated within a satellite access station. This may be the implementation for transparent/bent-pipe satellites wherein the satellites act as a reflector to the satellite earth access station(s).

For an embodiment, one or more of the plurality of the second base station components is collocated within a satellite access station. This may be the implementation for transparent/bent-pipe satellites wherein the satellites act as a reflector to the satellite earth access station(s).

For an embodiment, one or more of the plurality of the second base station components is collocated within a data center. This may be the implementation for transparent/bent-pipe satellites where the satellites act as a reflector to the satellite earth access station(s). For an embodiment, having the second wireless base station components in the data centers allows for flexibility, optimizing of resources.

An embodiment, of a LEO network with regenerative satellites utilizes the distributed RAN and multi-tiered scheduler system as outlined. However, in this architecture the RAN physical layer is deployed on the satellite payload instead of at ground stations, and can also include inter-satellite links to provide extended coverage over deep ocean regions.

For an embodiment, base station scheduling strategies play a critical role in optimizing communication during satellite transitions, especially for managing NPRACH (Narrowband Physical Random Access Channel) that occurs when a satellite switches. In addition to that buffering capabilities such as “store and forward” mechanisms are essential for temporarily holding data and maintaining seamless operations.

Due to rapidly moving satellites, imperfect antenna steering, weather conditions and changing beam patterns, the levels should be dynamically updated over the air in SIB2 over time, which aids in utilizing the first and second wireless base station resources efficiently, among other things.

Although specific embodiments have been described and illustrated, the embodiments are not to be limited to the specific forms or arrangements of parts so described and illustrated. The embodiments described are to only be limited by the claims.

What is claimed:

1. A method, comprising:
providing, by a satellite network, wireless satellite network coverage to a cell area, wherein the cell area is one of a plurality of coverage cell areas of the satellite network, comprising:
determining mapping, by the satellite network, wherein the mapping identifies a first serving wireless base station component, a second serving wireless base station component, a serving satellite, and a serving satellite access station for supporting wireless communication with a wireless device within the cell area, wherein the first wireless base station component and the second wireless base station component are mapped independently for each of the plurality of coverage cell areas, wherein the second wireless base station component communicates with a wireless device within the cell area through the first wireless base station component, wherein the first serving wireless base station component is one of a plurality of available first wireless base station components and performs signal modulation and demodulation, and wherein the second serving wireless base station component is one of a plurality of available second wireless base station components and performs a radio resource control (RRC) function; and
wirelessly communicating, by the satellite network, with the wireless device within the cell area through the serving satellite access station, the first wireless base station component, the second wireless base station component, and the serving satellite.

2. The method of claim 1, wherein the second serving wireless base station component supporting wireless coverage in the cell area remains static over time as the serving satellite changes.

3. The method of claim 1, wherein the first serving wireless base station component supporting wireless coverage in the cell area changes over time as the serving satellite changes.

4. The method of claim 1, wherein a location of the second wireless base station component changes over time.

5. The method of claim 1, wherein the first wireless base station component comprises multiple instances, wherein each instance processes signals for a different satellite beam from one or more satellites.

6. The method of claim 5, wherein the second wireless base station component comprises multiple instances, wherein each instance is associated with a different physical cell area or channel.

7. The method of claim 1, wherein the mapping further includes one or more of mapping between the first wireless base station component and the second wireless base station component, signal routing parameters, ephemeris broadcast information, or frequency allocation.

8. The method of claim 1, further comprising generating initial system block information by the second wireless base station component; and
updating the initial system block information by the first wireless base station component based on mapping of the serving satellite and the first wireless base station component.

9. The method of claim 1, wherein the mapping is based at least in part on locations of the serving satellite and the serving satellite access station and locations of instances of the first wireless base station component and the second wireless base station component.

10. The method of claim 1, wherein the mapping is based at least in part on current stored power available of the serving satellite.

11. The method of claim 1, wherein the mapping is based at least in part on a network load.

12. The method of claim 1, further comprising determining a radio resource schedule by the first wireless base station component based on a timing estimation information or channel estimation information between the wireless device and the first wireless base station component.

13. The method of claim 12, wherein the timing estimation information includes timing advance adjustment by the first wireless base station component.

14. The method of claim 1, wherein radio resource control related timers and parameters are defined based on a latency between the first wireless base station component and the second wireless base station component.

15. The method of claim 1, further comprising updating by a mapping table, channel routing information including a selection of channel allocation, a feeder link channel, a serving satellite selection, a first wireless base station component selection, and a second wireless base station component selection.

16. The method of claim 1, wherein one or more of the plurality of first base station components is collocated within a satellite.

17. The method of claim 1, wherein one or more of the plurality of first base station components is collocated within a satellite access station.

18. The method of claim 1, wherein one or more of the plurality of the second base station components is collocated within a satellite access station.

19. The method of claim 1, wherein one or more of the plurality of the second base station components is collocated within a data center.

20. A satellite network configured to:
provide wireless satellite network coverage to a cell area, wherein the cell area is one of a plurality of coverage cell areas of the satellite network, comprising the satellite network operating to:
determine mapping, wherein the mapping identifies a first serving wireless base station component, a second serving wireless base station component, a serving satellite, and a serving satellite access station for supporting wireless communication with a wireless device within the cell area, wherein the first wireless base station component and the second wireless base station component are mapped independently for each of the plurality of coverage cell areas, wherein the second wireless base station component communicates with a wireless device within the cell area through the first wireless base station component, wherein the first serving wireless base station component is one of a plurality of available first wireless base station components and performs signal modulation and demodulation, and wherein the second serving wireless base station component is one of a plurality of available second wireless base station components and performs a radio resource control (RRC) function; and
wirelessly communicate with the wireless device within the cell area through the serving satellite access station, the first wireless base station component, the second wireless base station component, and the serving satellite.
